(19) United States
(12) Patent Application Publication
(10) Pub. No.: US 2025/0244563 A1
(43) Pub. Date: Jul. 31, 2025

(54) OPTICAL LENS AND HEAD-MOUNTED DISPLAY DEVICE

(71) Applicant: Coretronic Corporation, Hsin-Chu (TW)

(72) Inventors: Tao-Hung Kuo, Hsin-Chu (TW); Po-Che Lee, Hsin-Chu (TW)

(73) Assignee: Coretronic Corporation, Hsin-Chu (TW)

(21) Appl. No.: 19/026,556

(22) Filed: Jan. 17, 2025

Related U.S. Application Data
(60) Provisional application No. 63/626,529, filed on Jan. 30, 2024.

(30) Foreign Application Priority Data
Apr. 1, 2024 (CN) 202410385501.X

(51) Int. Cl. G02B 13/00; G02B 9/60; G02B 27/01

(52) U.S. Cl. CPC G02B 13/0045; G02B 9/60; G02B 13/0055; G02B 27/0172

(57) ABSTRACT

An optical lens adapted to receive an image beam from an imaging element is provided. The optical lens includes a first lens element, a second lens element, a third lens element, and a fourth lens element with diopter arranged along an optical axis from a light incident-side to a light exit-side. The light incident surface of the first lens element is concave. The second lens element has negative diopter, and the light exit surface of the second lens element is convex. The third lens element has positive diopter, and the light incident surface of the third lens element is convex. The fourth lens element has positive diopter, and the light incident surface of the fourth lens element is concave. The image beam forms a stop on the light exit-side, and the image beam has the smallest beam cross-sectional area at the position of the stop.

### CROSS-REFERENCE TO RELATED APPLICATION

This application claims the priority benefit of U.S. provisional applications Ser. No. 63/626,529, filed on Jan. 30, 2024 and China application serial no. 202410385501.X, filed on Apr. 1, 2024. The entirety of the above-mentioned patent application is hereby incorporated by reference herein and made a part of this specification.

### BACKGROUND

### Technical Field

The disclosure relates to an optical module and an electronic device, and in particular to an optical lens and a head-mounted display device.

### Description of Related Art

With the emergence of multimedia imaging applications such as stereoscopic display and virtual reality, the demand for high-resolution display devices is gradually increasing in order to provide stunning visual effects.

Displays with waveguides (waveguide displays) may be divided into a self-luminous

panel framework, a transmissive panel framework, and a reflective panel framework according to types of image sources thereof. The image beam generated by the image source (panel) passes through the optical lens to form a virtual image, which is further displayed at a preset position in front of the user's eyes. When the optical lenses are used in waveguide displays, the design considerations of size, weight, resolution, and thermal drift are important issues.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The objects and advantages of the disclosure can be further understood from the technical features disclosed in the disclosure.

The disclosure provides an optical lens that receives an image beam from an imaging element. The optical lens sequentially includes a first lens element, a second lens element, a third lens element, and a fourth lens element with diopters arranged along an optical axis from a light incident-side to a light exit-side. Each of the first lens element, the second lens element, the third lens element and the fourth lens element includes a light incident surface facing the light incident-side and allowing the image beam to pass through and a light exit surface facing the light exit-side and allowing the image beam to pass through. The light incident surface of the first lens element is a concave surface. The second lens element has a negative diopter, and the light exit surface of the second lens element is a convex surface. The third lens element has a positive diopter, and the light incident surface of the third lens element is a convex surface. The fourth lens element has a positive diopter, and the light incident surface of the fourth lens element is a concave surface. The optical lens receives the image beam from the light incident-side. The image beam forms a stop on the light exit-side, and the image beam has the smallest beam cross-sectional area at a position of the stop.

The disclosure also provides a head-mounted display device, including the imaging element, the optical lens, and a waveguide element. The imaging element is used to provide the image beam. The optical lens is disposed on a transmission path of the image beam. The optical lens sequentially includes the first lens element, the second lens element, the third lens element, and the fourth lens with diopters arranged along the optical axis from the light incident-side to the light exit-side. Each of the first lens element, the second lens element, the third lens element and the fourth lens element includes the light incident surface facing the light incident-side and allowing the image beam to pass through and the light exit surface facing the light exit-side and allowing the image beam to pass through. The light incident surface of the first lens element is the concave surface. The second lens element has the negative diopter, and the light exit surface of the second lens element is the convex surface. The third lens element has the positive diopter, and the light incident surface of the third lens element is the convex surface. The fourth lens element has the positive diopter, and the light incident surface of the fourth lens element is the concave surface. The optical lens receives the image beam from the incident-side. The image beam forms the stop on the light exit-side, and the image beam has the smallest beam cross-sectional area at the position of the stop. The waveguide element is disposed on the light exit-side of the optical lens and has an optical coupling entrance and an optical coupling exit. The image beam from the imaging element passes through the optical lens and enters the waveguide element through the optical coupling entrance, and leaves the waveguide element through the optical coupling exit.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a head-mounted display device according to an embodiment of the disclosure.

FIG. 2 is a schematic diagram of the imaging module according to the first embodiment of the disclosure.

FIG. 3 is a diagram of astigmatism and distortion of the optical lens in FIG. 2.

FIG. 4 is a third-order aberration distribution diagram of the optical lens in FIG. 2.

FIG. 5A to FIG. 5D are modulation transfer function (MTF) curves of the optical lens in FIG. 2 at different temperatures.

FIG. 6 is a relative illumination distribution diagram of the optical lens in FIG. 2.

FIG. 7 is a schematic diagram of a TV distortion of the optical lens in FIG. 2.

FIG. 8 is a schematic diagram of an imaging module according to the second embodiment of the disclosure.

FIG. 9 is a diagram of the astigmatism and distortion of the optical lens in FIG. 8.

FIG. 10A to FIG. 10D are MTF curves of the optical lens in FIG. 8 at different temperatures.

FIG. 11 is a relative illumination distribution diagram of the optical lens in FIG. 8.

FIG. 12 is a schematic diagram of a TV distortion of the optical lens in FIG. 8.

FIG. 13 is a schematic diagram of an imaging module according to the third embodiment of the disclosure.

FIG. 14 is a diagram of astigmatism and distortion of the optical lens in FIG. 13.

FIG. 15A to FIG. 15D are MTF curves of the optical lens in FIG. 13 at different temperatures.

FIG. 16 is a relative illumination distribution diagram of the optical lens in FIG. 13.

FIG. 17 is a schematic diagram of a TV distortion of the optical lens in FIG. 13.

FIG. 18 is a schematic diagram of an imaging module according to the fourth embodiment of the disclosure.

FIG. 19 is a diagram of astigmatism and distortion of the optical lens in FIG. 18.

FIG. 20A to FIG. 20D are MTF curves of the optical lens in FIG. 18 at different temperatures.

FIG. 21 is a relative illumination distribution diagram of the optical lens in FIG. 18.

FIG. 22 is a schematic diagram of a TV distortion of the optical lens in FIG. 18.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure provides an optical lens and a head-mounted display device, which can reduce the size and have proper optical quality and thermal stability.

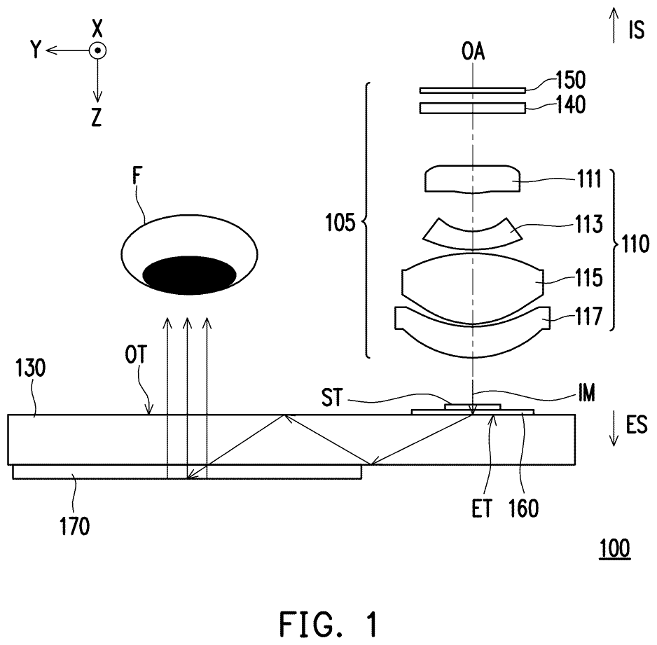

FIG. 1 is a schematic diagram of a head-mounted display device according to an embodiment of the disclosure. Referring to FIG. 1, this embodiment provides a head-mounted display device 100, including an optical lens 110, a waveguide element 130, and an imaging element 150. In this embodiment, the head-mounted display device 100 is, for example, a head-mounted display. The imaging element 150 is disposed on a light incident-side IS of the optical lens 110 to provide an image beam IM. The optical lens 110 is disposed on a transmission path of the image beam IM, and is suitable for receiving the image beam IM from the imaging element 150 (or the light incident-side IS). The optical lens 110 is a combination of multiple optical lens elements with different optical conditions, which is described in detail in subsequent paragraphs. In this embodiment, the imaging element 150 is a self-luminous imaging panel, such as a light-emitting diode display panel (LED display), an organic light-emitting diode display panel (OLED display) or a micro light-emitting diode display panel (micro LED display), and the disclosure is not limited thereto. In other words, since the self-luminous imaging element 150 is configured in this embodiment, the head-mounted display device 100 does not need to use a light-combining prism (that is, without light-combining prism). In this way, the volume of the head-mounted display device 100 may be reduced. In this embodiment, the imaging element 150 is an imaging panel that provides a monochromatic light source, and a wavelength of the image beam IM is a single wavelength. However, in different embodiments, the imaging element 150 may be an imaging panel of a multi-color light source, and the wavelength of the image beam IM may be multiple wavelengths, and the disclosure is not limited thereto. For example, in this embodiment, the imaging element 150 uses a 0.13-inch micro LED panel with a diagonal length of 3.2 mm, which is the size of an image circle of the optical lens 110. In this embodiment, a field view of the optical lens 110 is designed to be 26.5 degrees, and an image height is 1.6 mm. According to the relationship between focal length and image height: image height=focal length×tan (half of field of view), the focal length of the optical lens 110 is calculated to be designed preferably close to 6.79 mm.

The waveguide element 130 is disposed on a light exit-side ES of the optical lens 110. The waveguide element 130 has an upper surface and a lower surface (not numbered) opposite to each other and has an optical coupling entrance ET and an optical coupling exit OT. The optical coupling entrance ET and the optical coupling exit OT are respectively, for example, a surface area where the image beam IM is incident on the waveguide element 130 from the optical lens 110 and a surface area where the image beam IM leaves the waveguide element 130. In this embodiment, the optical coupling entrance ET and the optical coupling exit OT are both located on the upper surface of the waveguide element 130. The image beam IM from the imaging element 150 passes through the optical lens 110 and then enters the waveguide element 130 through the optical coupling entrance ET. The image beam IM is transmitted in the waveguide element 130. Finally, the image beam IM leaves the waveguide element 130 through the optical coupling exit OT and is projected to a target F, for example, eyes of a user of the head-mounted display device 100. The image beam IM forms a stop ST on the light exit-side ES of the optical lens 110. The image beam IM has the smallest beam cross-sectional area at the position of the stop ST. For example, in this embodiment, a diameter of the smallest beam cross-sectional area is 5.18 mm, which is close to the size of a normal human eye pupil (approximately 3 to 6 mm). Therefore, the image beam IM shrinks to the position of the stop ST after passing through the optical lens 110, and diverges after passing through the stop ST. Specifically, in this embodiment, the stop ST is formed at a position of the optical coupling entrance ET of the waveguide element 130 or a position close to the optical coupling entrance ET. In a reference plane formed by an X-axis and a Y-axis, a shape of the stop ST is, for example, substantially circular, and the length of the stop ST in the X-axis direction is substantially the same as that in the Y-axis direction.

Specifically, in this embodiment, the display device 100 further includes a protective cover 140, an anti-reflection element 160, and a reflection element 170. The optical lens 110, the protective cover 140, and the imaging element 150 may be collectively referred to as an imaging module 105. The protective cover 140 is disposed between the imaging element 150 and the optical lens 110 to protect the imaging element 150 from dust. The image beam IM provided by the imaging element 150 enters the optical lens 110 through the protective cover 140. On the other hand, the anti-reflection element 160 is disposed at the optical coupling entrance ET of the waveguide element 130. The anti-reflection element 160 may be, for example, an anti-reflection layer coated on the upper surface of the waveguide element 130 and corresponding to the optical coupling entrance ET, or the anti-reflection element 160 may be an anti-reflection structure on the upper surface of the waveguide element 130 and formed by surface treatment corresponding to the position of the optical coupling entrance ET. The anti-reflection element 160 is used to allow the image beam IM to enter the waveguide element 130 easily, so a ratio of reflection by the surface of the waveguide element 130 is thereby decreased. The reflection element 170 is disposed on the lower surface of the waveguide element 130 relative to the optical coupling exit OT. The reflection element 170 may be, for example, a reflection film layer coated on the lower surface of the waveguide element 130 relative to the optical coupling exit OT, or the reflection element 170 may be a reflection structure formed by surface treatment on the lower surface of the waveguide element 130. The reflection element 170 may reflect the image beam IM transmitted in the waveguide element 130 and transmit the image beam IM toward the optical coupling exit OT, so that the image beam IM in the waveguide element 130 may leave the waveguide element 130 more easily.

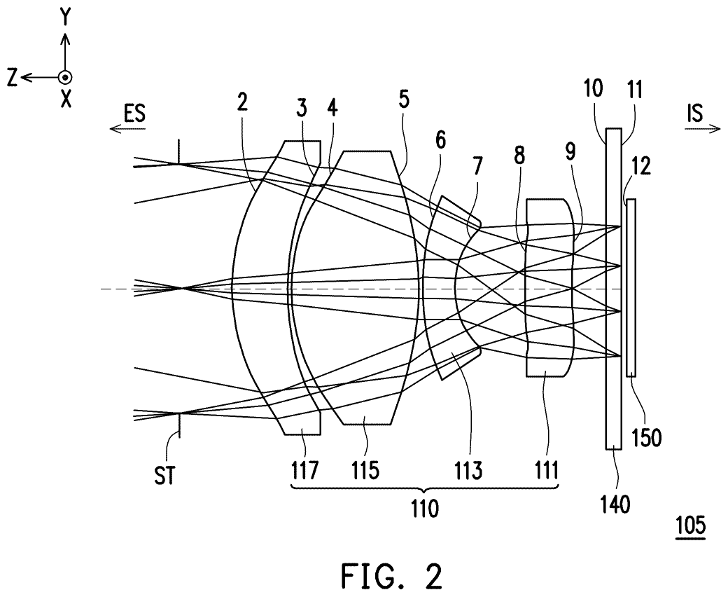

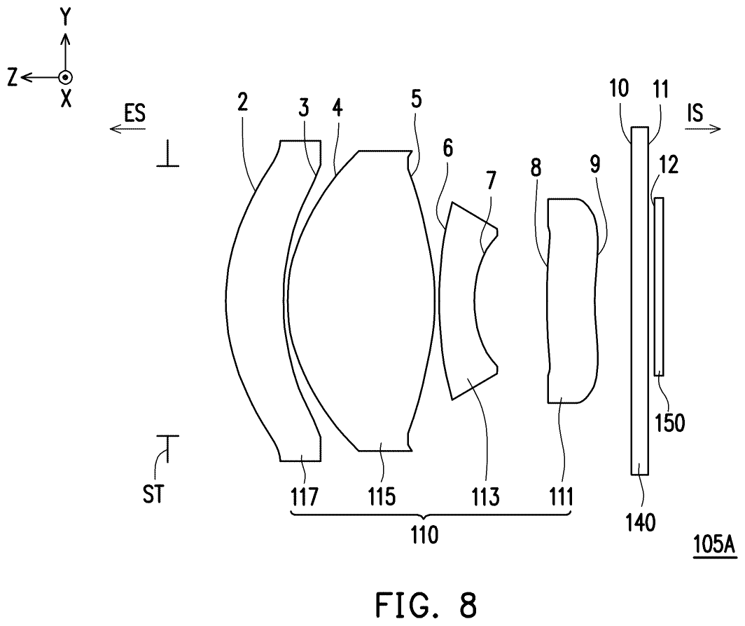

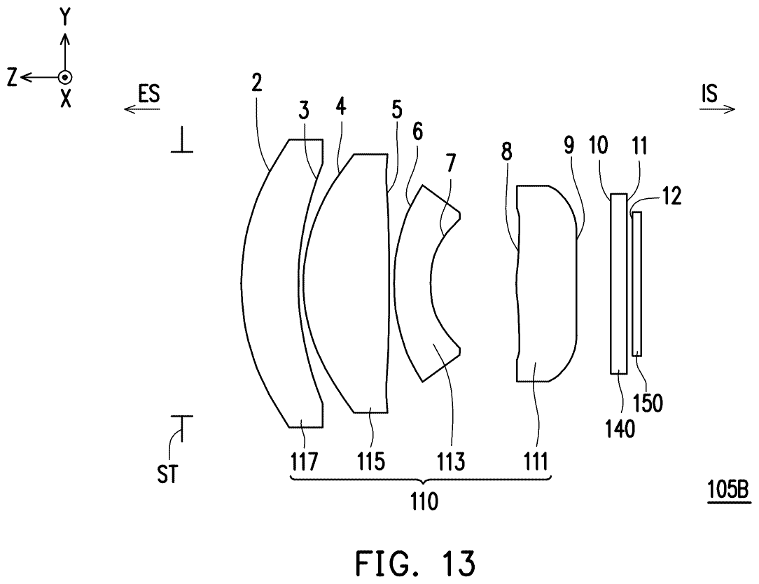

FIG. 2 is a schematic diagram of the imaging module according to the first embodiment of the disclosure. Referring to FIG. 1 and FIG. 2, the imaging module 105 shown in FIG. 2, FIG. 8, and FIG. 13 may at least be applied to the display device 100 shown in FIG. 1, so the following description takes the imaging module 105 shown in FIG. 2 as an example. In the imaging module 105 of the first embodiment, the optical lens 110 sequentially includes a first lens element 111, a second lens element 113, a third lens element 115, and a fourth lens element 117 with a diopter arranged along an optical axis OA from the light incident-side IS to the light exit-side ES. Each of the first lens element 111, the second lens element 113, the third lens element 115, and the fourth lens element 117 respectively include a light incident surface 9, 7, 5, 3 facing the light incident-side IS and allowing the image beam IM to pass through, and a light exit surface 8, 6, 4, 2 facing the light exit-side ES and allowing the image beam IM to pass through. In addition, the protective cover 140 in the imaging module 105 has a light incident surface 11 and a light exit surface 10. The imaging element 150 has an imaging surface 12 for emitting image light beams.

The first lens element 111 has a positive diopter. A material of the first lens element 111 is glass. The light incident surface 9 of the first lens element 111 is a concave surface facing the imaging element 150, and the light exit surface 8 of the first lens element 111 is a convex surface facing the stop ST. In this embodiment, the first lens element 111 is an aspherical lens. That is, the light incident surface 9 and the light exit surface 8 of the first lens element 111 are both aspheric surfaces, but the disclosure is not limited thereto.

The second lens element 113 has a negative diopter. A material of the second lens element 113 is glass. The light incident surface 7 of the second lens element 113 is a concave surface facing the imaging element 150. The light exit surface 6 of the second lens element 113 is a convex surface facing the stop ST. That is, the second lens element 113 is a convex-concave lens. In this embodiment, the second lens element 113 is the aspherical lens. That is, the light incident surface 7 and the light exit surface 6 of the second lens element 113 are both aspherical surfaces, but the disclosure is not limited thereto.

The third lens element 115 has a positive diopter. A material of the third lens element 115 is glass. The light incident surface 5 of the third lens element 115 is a convex surface facing the imaging element 150. The light exit surface 4 of the third lens element 115 is a convex surface facing the stop ST. That is, the third lens element 115 is a biconvex lens. In this embodiment, the third lens element 115 is the aspherical lens. That is, the light incident surface 5 and the light exit surface 4 of the third lens element 115 are both aspherical surfaces, but the disclosure is not limited thereto.

The fourth lens element 117 has a positive diopter. A material of the fourth lens element 117 is glass. The light incident surface 3 of the fourth lens element 117 is a concave surface facing the imaging element 150. The light exit surface 2 of the fourth lens element 117 is a convex surface facing the stop ST. That is, the fourth lens element 117 is a concave-convex lens. In this embodiment, the fourth lens element 117 is the aspherical lens. That is, the light incident surface 3 and the light exit surface 2 of the fourth lens element 117 are both aspherical surfaces, but the disclosure is not limited thereto.

In other words, in this embodiment, the materials of the first lens element 111 to the fourth lens element 117 are glass, and the first lens element 111 to the fourth lens element 117 are all aspherical lenses. In the optical lens 110, only the four lens elements have the diopter.

Other detailed optical data of the first embodiment are shown in Table 1 below. An effective focal length of the optical lens 110 of the first embodiment is 6.70 mm, a half field of view is 13.25 degrees, and the image height is 1.6 mm. It should be noted that a radius of curvature of the light incident surface 9 shown in Table 1 refers to the radius of curvature of the light incident surface 9 of the first lens element 111 on the optical axis OA. The radius of curvature of the light exit surface 8 refers to the radius of curvature of the light exit surface 8 of the first lens element 111 on the optical axis OA, and so on. A distance between the light incident surface 9 (0.70 mm as shown in Table 1) refers to the distance between the light incident surface 9 and the next surface (in this example, the light exit surface 10 of the protective cover 140) on the optical axis OA. That is, the distance between a first lens element 111 and the protective cover 140 on the optical axis OA is 0.70 mm. The distance of the light exit surface 8 (0.97 mm as shown in Table 1) refers to the distance between the light exit surface 8 and the light incident surface 9 of the first lens element 111 on the optical axis OA. That is, a thickness of the first lens element 111 on the optical axis OA is 0.97 mm, and so on.

TABLE 1
first embodiment
effective focal length = 6.70 mm, half view angle = 13.25°, image height = 1.6 mm.

| | | radius of | | | |
|---|---|---|---|---|---|
| | | curvature | distance | refractive | Abbe |
| element | surface | (mm) | (mm) | index | number |
| virtual image | | infinity | infinity | | |
| stop ST | | infinity | 1.10 | | |
| fourth lens element 117 | light exit surface 2 | 4.10 | 1.14 | 1.77 | 49.5 |
| | light incident surface 3 | 5.06 | 0.08 | | |
| third lens element 115 | light exit surface 4 | 3.62 | 2.63 | 1.48 | 70.4 |
| | light incident surface 5 | −4.13 | 0.08 | | |
| second lens element 113 | light exit surface 6 | 4.37 | 0.67 | 1.72 | 29.2 |
| | light incident surface 7 | 1.58 | 1.43 | | |
| first lens element 111 | light exit surface 8 | 5.98 | 0.97 | 1.77 | 49.5 |
| | light incident surface 9 | 6.21 | 0.70 | | |
| protective cover 140 | light exit surface 10 | infinity | 0.30 | 1.50 | 61.1 |
| | light incident surface 11 | infinity | 0.01 | | |
| imaging element 150 | imaging surface 12 | infinity | | | |

In the optical lens 110 of the first embodiment, an aperture (f/#) of the optical lens 110 is 1.294. The effective focal length of the optical lens 110 is 6.70 mm. The focal length of the third lens element 115 is 4.44 mm. The Abbe number of the third lens element 115 is 70.42.

The focal length of the fourth lens element 117 is 18.32 mm. In other words, the optical lens 110 of the first embodiment satisfies the following conditional expression:
the optical lens 110 satisfies 0.3<f_{L3}/f<3;
the optical lens 110 satisfies V_{L3}>30;
the optical lens 110 satisfies |f_{L4}/f|>1; and
the optical lens 110 satisfies the aperture f/#<2,
where
f_{L3} is the focal length of the third lens element 115;
f is the effective focal length of the optical lens 110;
V_{L3} is the Abbe number of the third lens element 115; and
f_{L4} is the focal length of the fourth lens element 117.

In addition, at least one of the lens elements with the positive diopter in the optical lens 110 satisfies the conditional expression:

$$dn / dt < 0 ,$$

where dn/dt is the change in the refractive index of the lens element at unit temperature.

In this embodiment, the lens elements with the positive diopter in the optical lens 110 are the first lens element 111, the third lens element 115, and the fourth lens element 117. The third lens element 115 is selected to use a glass material in which the value of dn/dt is negative, and the first lens element 111, the second lens element 113, and the fourth lens element 117 are selected to use a glass material in which the value of dn/dt is positive, so that the optical lens 110 may take into account a thermal drift to control within an acceptable range.

In this embodiment, a total of eight surfaces including the light incident surfaces 9, 7, 5, 3 and the light exit surfaces 8, 6, 4, 2 are aspherical surfaces, and the aspherical surfaces are defined according to the following formula:

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{2 i} \times {Y}^{2 i} \qquad ( 1 )$$

Y is the distance between a point on a curve on the aspheric surface and the optical axis;
Z is a depth of the aspheric surface, i.e., a vertical distance between a point on the aspheric surface whose distance to the optical axis is Y and a tangent plane tangent to a vertex on the optical axis of the aspheric surface;
R is the radius of curvature of a lens surface;
K is a conic constant;
a₂ᵢ is the 2i-th-order aspheric coefficient.

In this embodiment, the aspheric coefficients of the above aspheric surfaces in formula (1) are shown in Table 2 below. Here, the column number 9 in Table 2 indicates the aspherical coefficients of the light incident surface 9 of the first lens element 111, and other columns may be deduced by analogy. In the present embodiment, the second-order aspheric coefficient a₂ of each aspheric surface is zero and thus is not listed in the table.

TABLE 2

| surface | K | a₄ | a₆ | a₈ | a₁₀ | a₁₂ | a₁₄ |
|---|---|---|---|---|---|---|---|
| 2 | 0.00E+00 | −9.82E−04 | 2.01E−04 | −9.88E−05 | 1.66E−05 | −1.16E−06 | 8.17E−11 |
| 3 | 0.00E+00 | 1.22E−03 | −3.69E−04 | −2.69E−05 | 3.12E−05 | −5.51E−06 | 2.54E−07 |
| 4 | 0.00E+00 | 2.52E−03 | −1.77E−03 | 4.35E−04 | −6.37E−05 | 2.50E−06 | 5.93E−08 |
| 5 | 0.00E+00 | 3.01E−02 | −7.39E−03 | 8.74E−04 | −2.28E−05 | −5.37E−06 | 4.56E−07 |
| 6 | 0.00E+00 | −2.72E−02 | 2.11E−02 | −9.26E−03 | 2.51E−03 | −3.96E−04 | 2.87E−05 |
| 7 | 0.00E+00 | −8.18E−02 | 4.36E−02 | −1.67E−02 | 3.49E−03 | −7.44E−16 | −5.54E−18 |
| 8 | 0.00E+00 | −2.48E−02 | −1.78E−02 | 2.43E−02 | −1.65E−02 | 5.76E−03 | −7.75E−04 |
| 9 | 0.00E+00 | −3.66E−02 | −1.74E−03 | 1.71E−03 | −1.86E−03 | 8.00E−04 | −1.14E−04 |

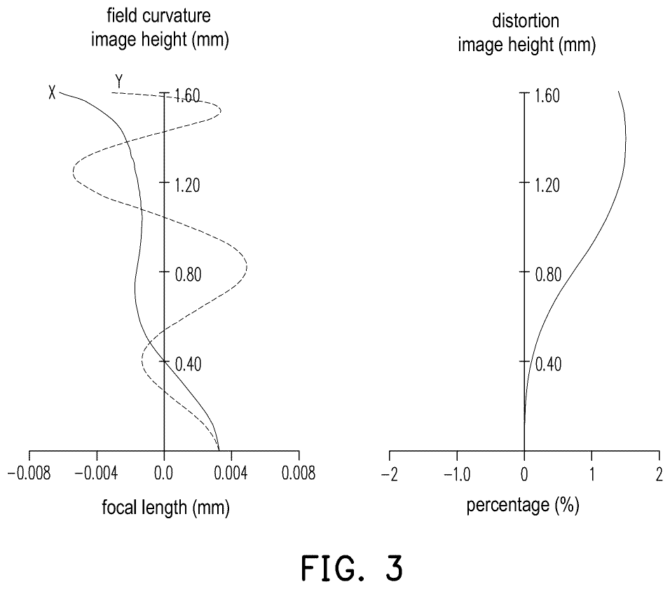

FIG. 3 is a diagram of astigmatism and distortion of the optical lens in FIG. 2. Referring to FIG. 3, FIG. 3 illustrates a field curvature aberration in a sagittal direction (labeled X) and a tangential direction (labeled Y), and a distortion aberration of the optical lens 110 of the first embodiment. It may be seen from FIG. 3 that the field curvature aberration of the optical lens 110 of this embodiment falls within ±0.008 mm, indicating that the optical lens 110 of the first embodiment can effectively eliminate aberrations. The distortion aberration diagram shows that the distortion aberration is maintained within the range of ±2%, indicating that the distortion aberration of the first embodiment satisfies the imaging quality requirements of the optical lens 110, and the optical lens 110 can provide proper imaging quality.

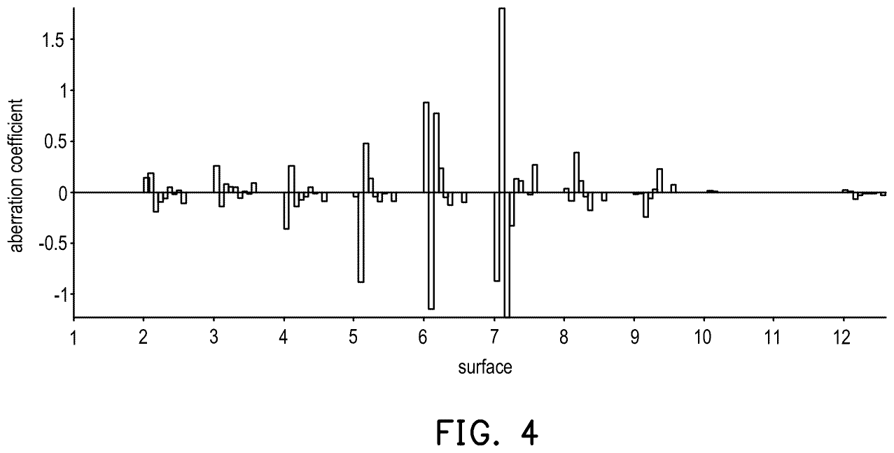

FIG. 4 is a third-order aberration distribution diagram of the optical lens in FIG. 2. Referring to FIG. 4, FIG. 4 shows aberration coefficients of various aberrations (including spherical aberration, coma aberration, astigmatism, field curvature, distortion, chromatic aberration, Petzval field curvature, etc.) generated when the image beam IM passes through the light incident surfaces 9, 7, 5, 3 and the light exit surfaces 8, 6, 4, 2. In this embodiment, it may be seen from FIG. 4 that a combined aberration of the light exit surface 6 of the second lens element 113 and the light incident surface 5 of the third lens element 115 and the aberration of the light incident surface 7 of the second lens element 113 may offset each other. Therefore, proper image quality can be provided.

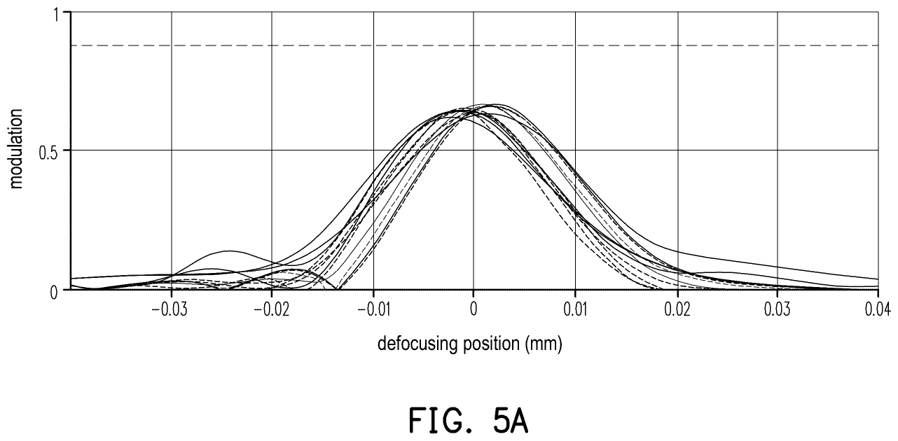

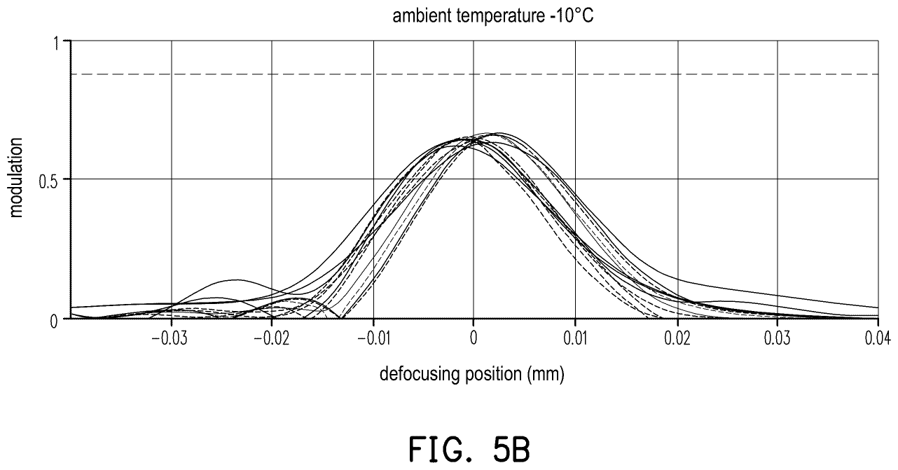

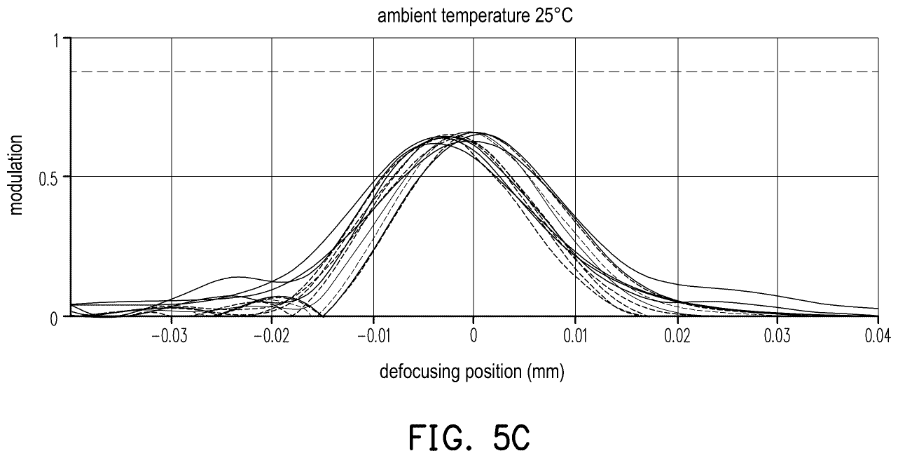

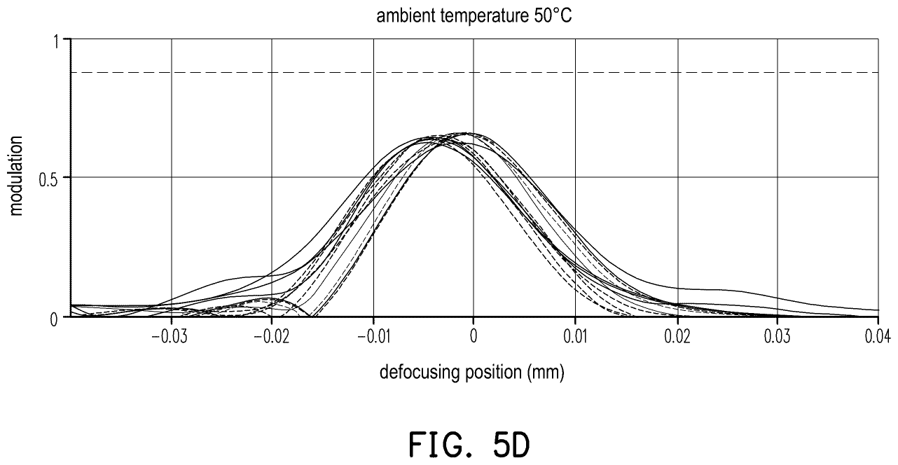

FIG. 5A to FIG. 5D are modulation transfer function (MTF) curves of the optical lens in FIG. 2 at different temperatures. Referring to FIG. 5A to FIG. 5D, FIG. 5A shows a MTF curve of a green band of each lens element in the optical lens 110 at normal temperature; FIG. 5B to FIG. 5D respectively show the MTF curves of the optical lens 110 when the ambient temperatures are −10° C., 25° C., and 50° C. When the ambient temperatures of the first embodiment are −10° C., 25° C., and 50° C. respectively, the values of the temperatures (° C.) of the first lens element 111, the second lens element 113, the third lens element 115, and the fourth lens element 117 of the optical lens 110 as shown in Table 3 below. It may be seen from FIG. 5A to FIG. 5D that when the optical lens 110 provided in the first embodiment is applied in thermal equilibrium within the ambient temperature range from −10°° C. to 50°° C. without re-adjusting the focal length thereof, the back focus of the optical lens has a thermal drift less than 0.01 mm corresponding to the center point of the projection image. Therefore, the proper image quality can be provided.

TABLE 3

| ambient | fourth lens | third lens | second lens | first lens |
|---|---|---|---|---|
| temperature | element 117 | element 115 | element 113 | element 111 |
| −10° C. | 4° C. | 7° C. | 11° C. | 14° C. |
| 25° C. | 39° C. | 42° C. | 46° C. | 49° C. |
| 50° C. | 64° C. | 67° C. | 71° C. | 74° C. |

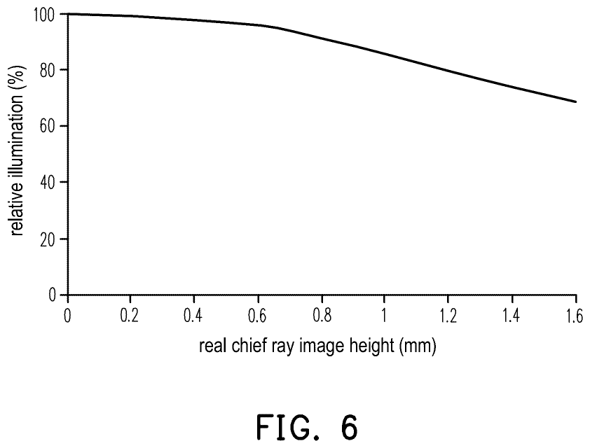

FIG. 6 is a relative illumination distribution diagram of the optical lens in FIG. 2. FIG.

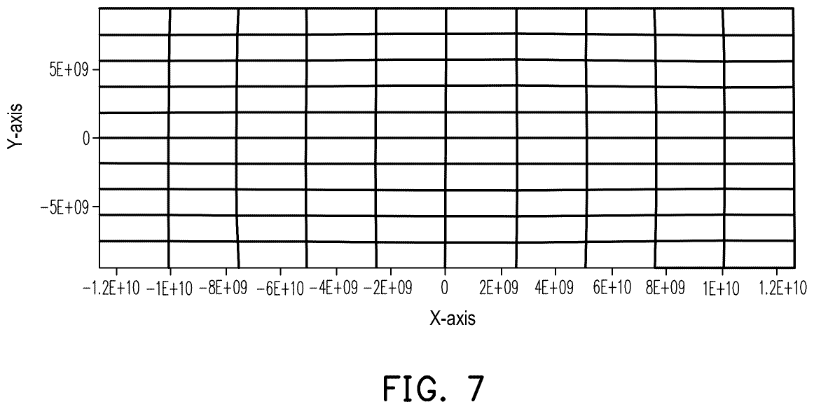

7 is a schematic diagram of a TV distortion of the optical lens in FIG. 2. Referring to FIG. 6 and FIG. 7, in this embodiment, it may be seen from FIG. 6 that under different chief ray image height simulations, the relative illumination of the optical lens 110 may be greater than 60%. It may be seen from FIG. 7 that when the projection distance is 20 meters, the TV distortion is less than 0.4%. Therefore, the proper image quality can be provided.

In this way, the imaging module 105 of the first embodiment is designed to use a smaller 0.13-inch single-color micro light-emitting diode panel as the imaging element 150, so no additional three-color light-combining prism is needed, which allows the reduction of the overall volume of the imaging module 105. In addition, the projected image of the optical lens 110 of the first embodiment has a high resolution up to 125 lp/mm. In addition, the number of lenses with the diopter in the optical lens 110 of the first embodiment is only four, so the back focal length can be reduced, and the overall volume of optical lens 110 can be reduced. In addition, the selection of the positive and negative diopters of the lens elements of the optical lens 110 with the positive and negative dn/dt of the first embodiment takes into account the thermal drift under a specific lens temperature difference to control within an acceptable range. In addition, through the ultra-large aperture (f/#<2) design of the first embodiment, the optical lens 110 still has sufficient brightness when outputting images using only the imaging element 150 of single color.

In order to fully illustrate various implementation aspects of the disclosure, other embodiments of the disclosure will be described below. It should be noticed that reference numbers of the elements and a part of contents of the aforementioned embodiment are also used in the following embodiments, where the same reference numbers denote the same or like components, and descriptions of the same technical contents are omitted. The aforementioned embodiment may be referred for descriptions of the omitted parts, and detailed descriptions thereof are not repeated in the following embodiments.

FIG. 8 is a schematic diagram of an imaging module according to the second embodiment of the disclosure. An imaging module 105A of the second embodiment is roughly similar to the imaging module 105 of the first embodiment, and the differences between the two are as follows: various optical data and the aspherical coefficients of the optical lens 110 and the parameters between the lens elements 111, 113, 115, and 117 are more or less different. Furthermore, in this embodiment, the first lens element 111 has the negative diopter. Other detailed optical data of the second embodiment are shown in Table 4 below.

TABLE 4
second embodiment
effective focal length = 6.71 mm, half view angle = 13.25°, image height = 1.6 mm.

| | | radius of | | | |
|---|---|---|---|---|---|
| | | curvature | distance | refractive | Abbe |
| element | surface | (mm) | (mm) | index | number |
| virtual image | | infinity | infinity | | |
| stop ST | | infinity | 1.10 | | |
| fourth lens element 117 | light exit surface 2 | 4.03 | 1.09 | 1.77 | 49.5 |
| | light incident surface 3 | 4.52 | 0.08 | | |
| third lens element 115 | light exit surface 4 | 3.20 | 2.80 | 1.48 | 70.4 |
| | light incident surface 5 | −3.75 | 0.08 | | |
| second lens element 113 | light exit surface 6 | 6.28 | 0.65 | 1.72 | 29.2 |
| | light incident surface 7 | 1.78 | 1.37 | | |
| first lens element 111 | light exit surface 8 | 5.52 | 0.93 | 1.77 | 49.5 |
| | light incident surface 9 | 5.00 | 0.70 | | |
| protective cover140 | light exit surface 10 | infinity | 0.30 | 1.50 | 61.1 |
| | light incident surface 11 | infinity | 0.01 | | |
| imaging element 150 | imaging surface 12 | infinity | | | |

It is also worth noting that in the optical lens 110 of the second embodiment, the aperture f/# of the optical lens 110 is 1.296. The effective focal length of the optical lens 110 is 6.71 mm. The focal length of the third lens element 115 is 3.77 mm. The Abbe number of the third lens element 115 is 70.42. The focal length of the fourth lens element 117 is −305.96 mm. In this embodiment, the third lens element 115 with the positive diopter is selected to use a glass material in which the value of dn/dt is negative, while the first lens element 111, the second lens element 113, and the fourth lens element 117 are selected with a glass material in which the value of dn/dt is positive. In other words, the optical lens 110 of the second embodiment also conforms to the conditional expression in the optical lens 110 of FIG. 1.

In this embodiment, the aspheric coefficients of the aspheric surfaces in formula (1) are shown in Table 5 below. In the present embodiment, the second-order aspheric coefficient a₂ of each aspheric surface is zero and thus is not listed in the table.

TABLE 5

| surface | K | a₄ | a₆ | a₈ | a₁₀ | a₁₂ | a₁₄ |
|---|---|---|---|---|---|---|---|
| 2 | 0.00E+00 | −1.11E−03 | 3.00E−05 | −1.37E−05 | −3.38E−06 | 7.45E−07 | −7.13E−08 |
| 3 | 0.00E+00 | −2.00E−03 | 4.25E−04 | −4.91E−05 | −7.50E−06 | 6.14E−07 | −1.40E−08 |
| 4 | 0.00E+00 | −2.52E−03 | 1.12E−04 | 2.73E−05 | −1.81E−05 | −1.03E−06 | 2.28E−07 |
| 5 | 0.00E+00 | 3.24E−02 | −6.94E−03 | 5.97E−04 | 4.40E−05 | −1.32E−05 | 9.03E−07 |
| 6 | 0.00E+00 | −3.16E−02 | 2.48E−02 | −1.04E−02 | 2.59E−03 | −3.69E−04 | 2.48E−05 |
| 7 | 0.00E+00 | −8.13E−02 | 5.14E−02 | −1.95E−02 | 4.97E−03 | −3.96E−16 | −2.15E−18 |
| 8 | 0.00E+00 | −3.27E−02 | −1.61E−02 | 2.50E−02 | −1.80E−02 | 6.64E−03 | −9.69E−04 |
| 9 | 0.00E+00 | −4.31E−02 | −4.58E−04 | 1.34E−03 | −1.69E−03 | 7.76E−04 | −1.22E−04 |

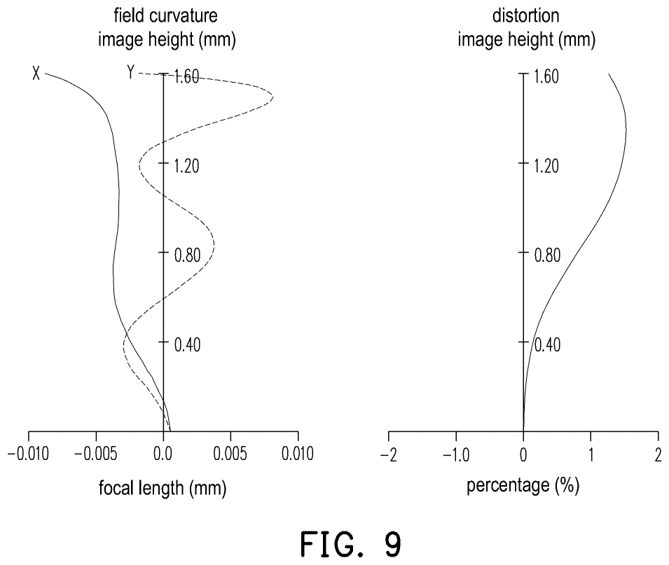

FIG. 9 is a diagram of astigmatism and distortion of the optical lens in FIG. 8. Referring to FIG. 9, FIG. 9 illustrates the field curvature aberration in the sagittal direction (labeled X) and the tangential direction (labeled Y), and the distortion aberration of the optical lens 110 of the second embodiment. It may be seen from FIG. 9 that the field curvature aberration of the optical lens 110 of this embodiment falls within ±0.010 mm, indicating that the optical lens 110 of the second embodiment can effectively eliminate aberrations. The distortion aberration diagram shows that the distortion aberration is maintained within the range of ±2%, indicating that the distortion aberration of the second embodiment satisfies the imaging quality requirements of the optical lens 110, and the optical lens 110 can provide proper imaging quality.

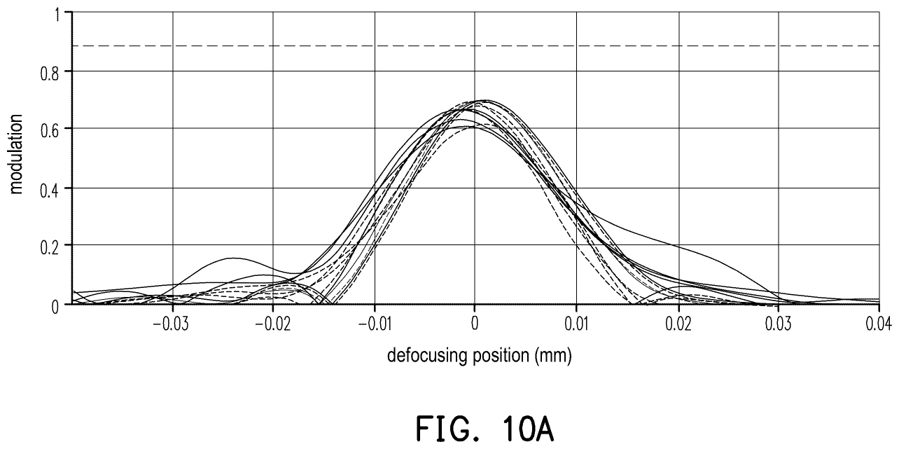

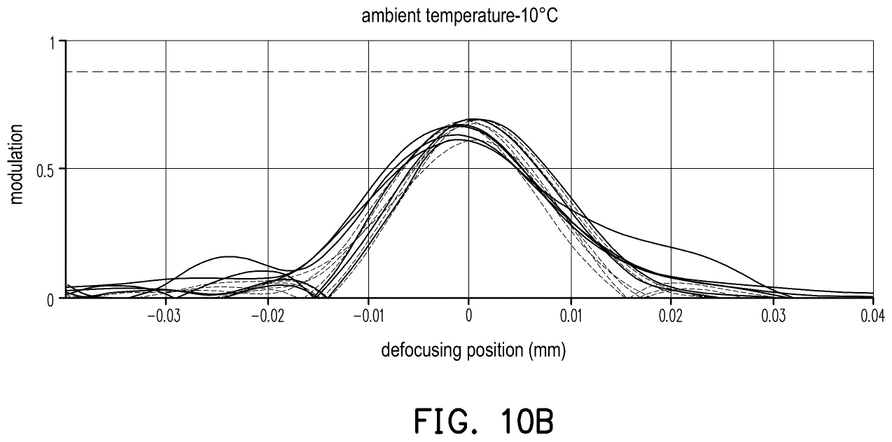

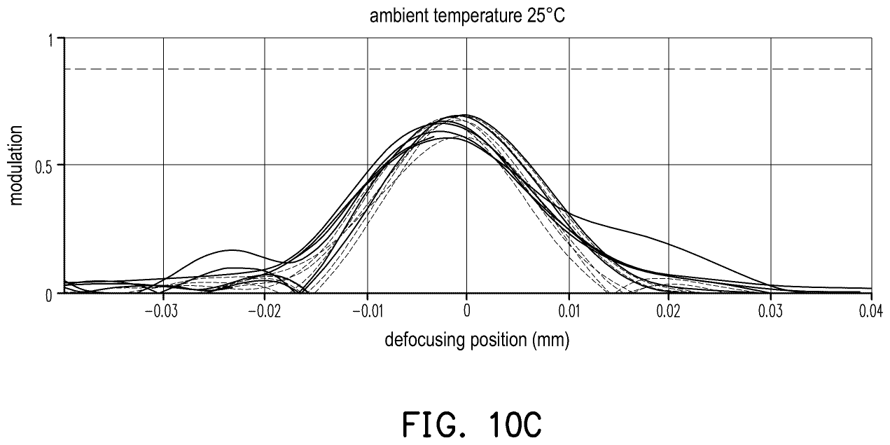

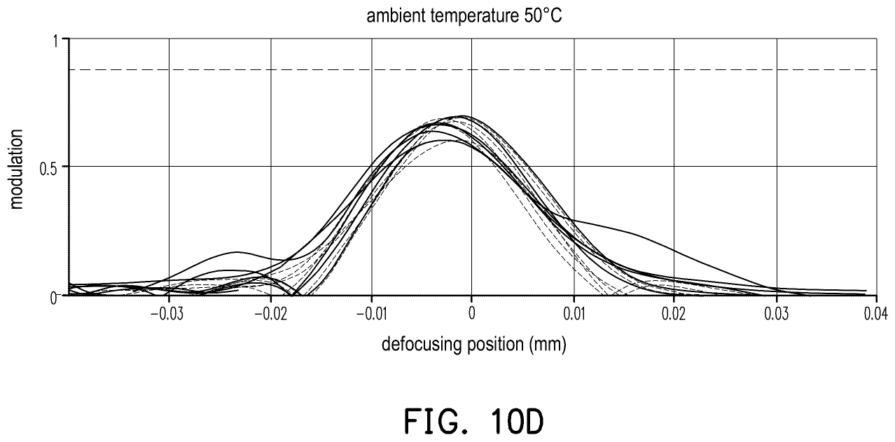

FIG. 10A to FIG. 10D are MTF curves of the optical lens in FIG. 8 at different temperatures. Referring to FIG. 10A to FIG. 10D, FIG. 10A shows the MTF curve of the green band of each lens in the optical lens 110 at normal temperature; FIG. 10B to FIG. 10D respectively show the MTF curves of the optical lens 110 when the ambient temperatures are −10° C., 25° C., and 50° C. When the ambient temperatures of the second embodiment are −10° C., 25° C., and 50° C. respectively, the values of temperatures (° C.) of the first lens element 111, the second lens element 113, the third lens element 115, and the fourth lens element 117 of the optical lens 110 are shown in Table 6 below. It may be seen from FIG. 10A to FIG. 10D that when the optical lens 110 of the second embodiment is applied in thermal equilibrium within the ambient temperature range from −10° C. to 50° C. without re-adjusting the focal length thereof, the back focus of the optical lens has a thermal drift less than 0.01 mm corresponding to the center point of the projection image. Therefore, the proper image quality can be provided.

TABLE 6

| ambient | fourth lens | third lens | second lens | first lens |
|---|---|---|---|---|
| temperature | element 117 | element 115 | element 113 | element 111 |
| −10° C. | 4° C. | 7° C. | 11° C. | 14° C. |
| 25° C. | 39° C. | 42° C. | 46° C. | 49° C. |
| 50° C. | 64° C. | 67° C. | 71° C. | 74° C. |

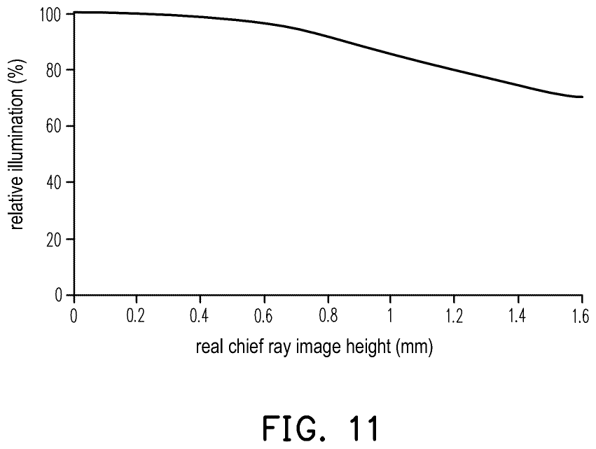

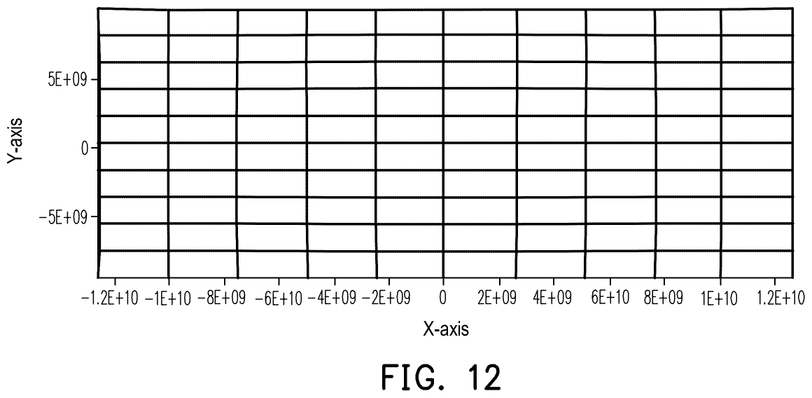

FIG. 11 is a relative illumination distribution diagram of the optical lens in FIG. 8. FIG. 12 is a schematic diagram of the TV distortion of the optical lens in FIG. 8. Referring to FIG. 11 and FIG. 12, in this embodiment, it may be seen from FIG. 11 that under different chief ray image height simulations, the relative illuminations of the optical lens 110 may be greater than 60%. It may be seen from FIG. 12 that when the projection distance is 20 meters, the TV distortion is less than 0.4%. Therefore, the proper image quality can be provided.

FIG. 13 is a schematic diagram of an imaging module according to the third embodiment of the disclosure. An imaging module 105B of the third embodiment is roughly similar to the imaging module 105 of the first embodiment, and the differences between the two are as follows: various optical data and the aspherical coefficients of the optical lens 110 and the parameters between the lens elements 111, 113, 115, and 117 are more or less different. Furthermore, in this embodiment, the second lens element 113 is a spherical lens. Other detailed optical data of the third embodiment are shown in Table 7 below.

TABLE 7
third embodiment
effective focal length = 6.78 mm, half view angle = 13.25°, image height = 1.6 mm.

| | | radius of | | | |
|---|---|---|---|---|---|
| | | curvature | distance | refractive | Abbe |
| element | surface | (mm) | (mm) | index | number |
| virtual image | | infinity | infinity | | |
| stop ST | | infinity | 1.20 | | |
| fourth lens element 117 | light exit surface 2 | 4.61 | 1.16 | 1.86 | 37.1 |
| | light incident surface 3 | 6.45 | 0.10 | | |
| third lens element 115 | light exit surface 4 | 3.44 | 1.72 | 1.62 | 63.8 |
| | light incident surface 5 | −100.93 | 0.10 | | |
| second lens element 113 | light exit surface 6 | 3.58 | 0.73 | 1.96 | 17.5 |
| | light incident surface 7 | 1.67 | 1.75 | | |
| first lens element 111 | light exit surface 8 | 8.33 | 1.20 | 1.77 | 49.5 |
| | light incident surface 9 | 40.03 | 0.72 | | |
| protective cover 140 | light exit surface 10 | infinity | 0.30 | 1.50 | 61.1 |
| | light incident surface 11 | infinity | 0.01 | | |
| imaging element 150 | imaging surface 12 | infinity | | | |

In the optical lens 110 of the third embodiment, the aperture f/# of the optical lens 110 is 1.294. The effective focal length of the optical lens 110 is 6.78 mm. The focal length of the third lens element 115 is 5.34 mm. The Abbe number of the third lens element 115 is 63.76.

The effective focal length of the fourth lens element 117 is 14.51 mm. In this embodiment, the third lens element 115 with the positive diopter is selected to use a glass material in which the value of dn/dt negative, while the first lens element 111, the second lens element 113, and the fourth lens element are selected with a glass material with in which the value of dn/dt is positive. In other words, the optical lens 110 of the third embodiment also conforms to the conditional expression in the optical lens 110 of FIG. 1.

In this embodiment, the aspheric coefficients of the aspheric surfaces in formula (1) are shown in Table 8 below. In the present embodiment, the second-order aspheric coefficient a₂ of each aspheric surface is zero and thus is not listed in the table.

TABLE 8

| surface | K | a₄ | a₆ | a₈ | a₁₀ | a₁₂ | a₁₄ |
|---|---|---|---|---|---|---|---|
| 2 | 0.00E+00 | 6.19E−04 | −1.54E−04 | 6.53E−05 | −1.71E−05 | 1.70E−06 | −7.31E−08 |
| 3 | 0.00E+00 | 5.94E−04 | 5.39E−04 | −7.84E−05 | −1.73E−05 | 4.39E−06 | −2.90E−07 |
| 4 | 0.00E+00 | −3.85E−03 | 8.81E−04 | −2.64E−04 | 1.73E−05 | 1.95E−06 | −1.77E−07 |
| 5 | 0.00E+00 | −1.84E−03 | 3.13E−04 | −1.53E−04 | 5.43E−05 | −7.53E−06 | 5.03E−07 |
| 8 | 0.00E+00 | −8.53E−03 | −1.24E−02 | 1.45E−02 | −1.21E−02 | 4.84E−03 | −8.28E−04 |
| 9 | 0.00E+00 | −1.55E−02 | −2.35E−03 | −2.76E−03 | 9.11E−04 | −1.23E−04 | 2.52E−06 |

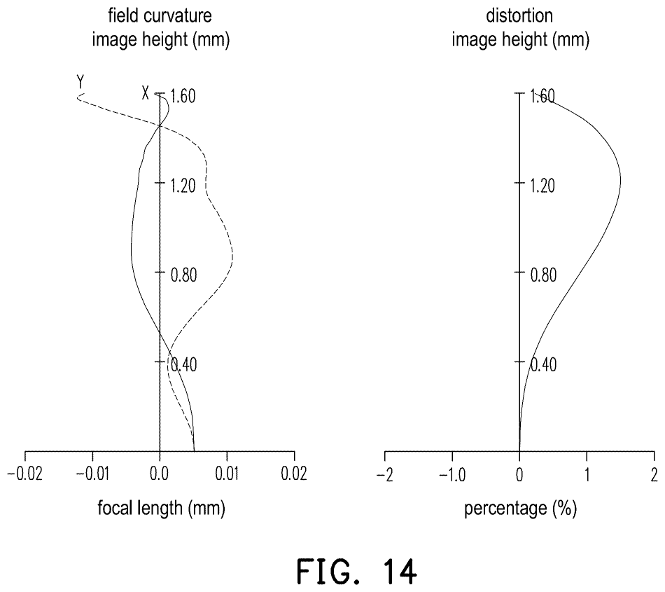

FIG. 14 is a diagram of astigmatism and distortion of the optical lens in FIG. 13. Referring to FIG. 14, FIG. 14 illustrates the field curvature aberration in the sagittal direction (labeled X) and the tangential direction (labeled Y), and the distortion aberration of the optical lens 110 of the third embodiment. It may be seen from FIG. 14 that the field curvature aberration of the optical lens 110 of this embodiment falls within ±0.020 mm, indicating that the optical lens 110 of the third embodiment can effectively eliminate aberrations. The distortion aberration diagram shows that the distortion aberration is maintained within the range of ±2%, indicating that the distortion aberration of the third embodiment satisfies the imaging quality requirements of the optical lens 110, and the optical lens 110 can provide good imaging quality.

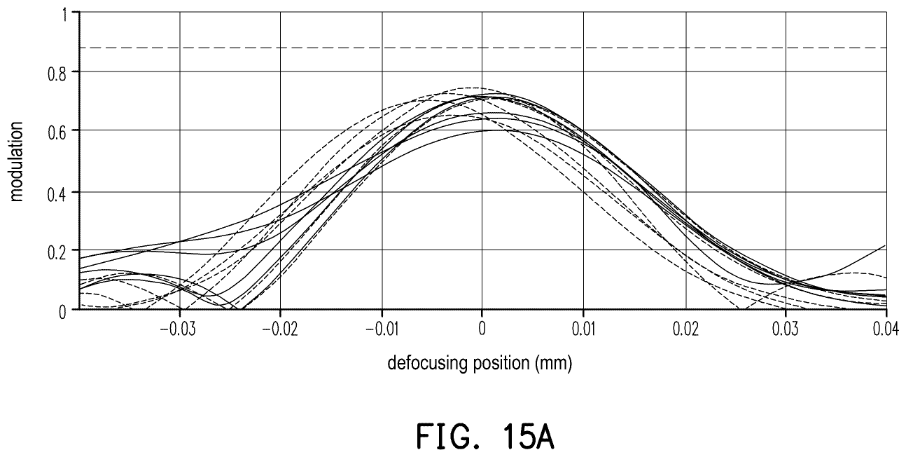

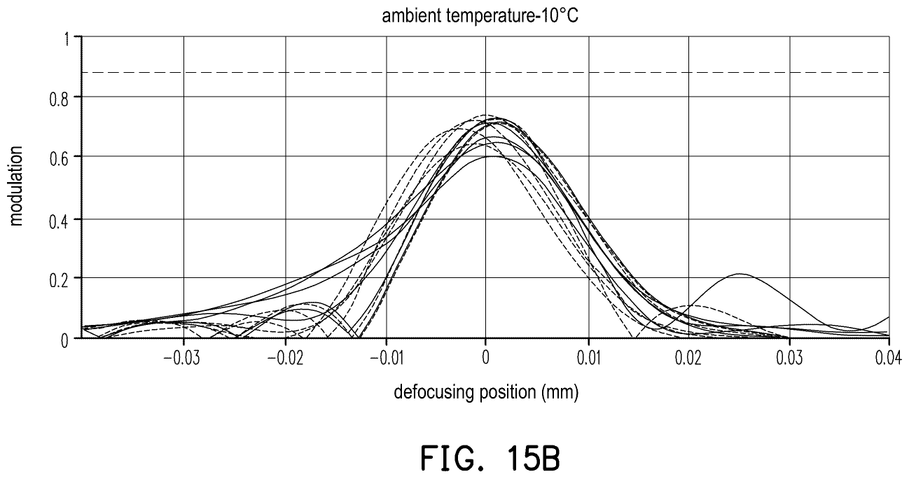

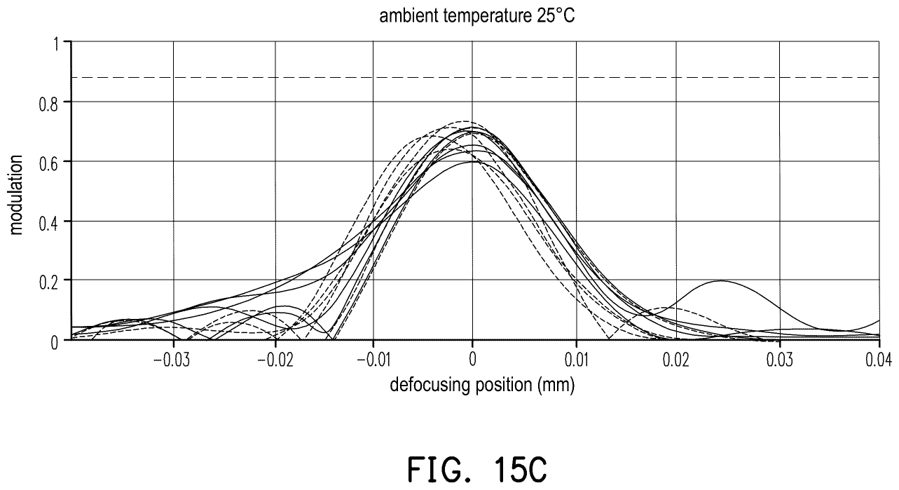

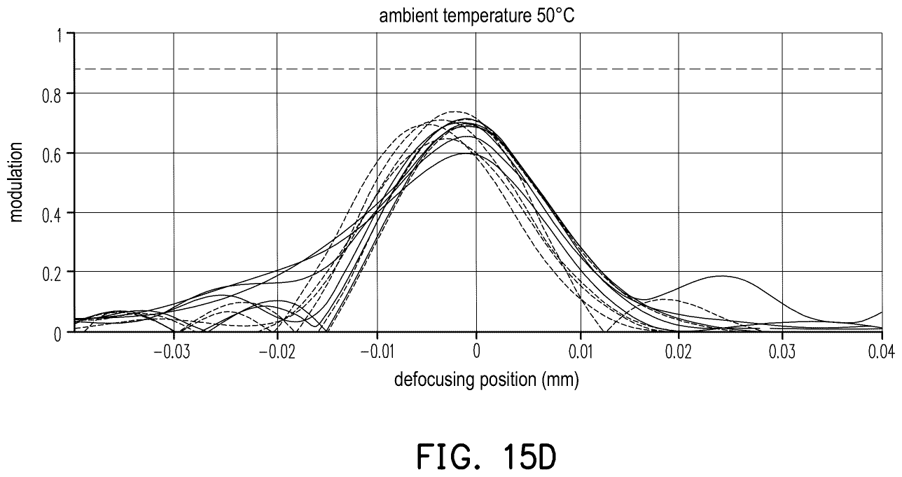

FIG. 15A to FIG. 15D are MTF curves of the optical lens in FIG. 13 at different temperatures. Referring to FIG. 15A to FIG. 15D, FIG. 15A shows the MTF curve of the green band of each lens in the optical lens 110 at normal temperature; FIG. 15B to FIG. 15D respectively show the MTF curves of the optical lens 110 when the ambient temperatures are −10° C., 25° C., and 50° C. When the ambient temperatures of the third embodiment are −10°° C., 25° C., and 50° C. respectively, the values of temperatures (° C.) of the first lens element 111, the second lens element 113, the third lens element 115, and the fourth lens element 117 of the optical lens 110 are shown in Table 9 below. It may be seen from FIG. 15A to FIG. 15D, when the optical lens 110 of the third embodiment is applied in thermal equilibrium within the ambient temperature range from −10° C. to 50° C. without re-adjusting the focal length thereof, the back focus of the optical lens has a thermal drift less than 0.01 mm corresponding to the center point of the projection image. Therefore, the proper image quality can be provided.

TABLE 9

| ambient | fourth lens | third lens | second lens | first lens |
|---|---|---|---|---|
| temperature | element 117 | element 115 | element 113 | element 111 |
| −10° C. | 4° C. | 7° C. | 11° C. | 14° C. |
| 25° C. | 39° C. | 42° C. | 46° C. | 49° C. |
| 50° C. | 64° C. | 67° C. | 71° C. | 74° C. |

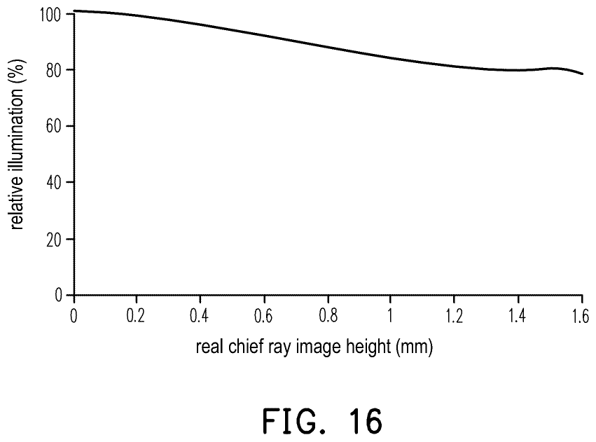

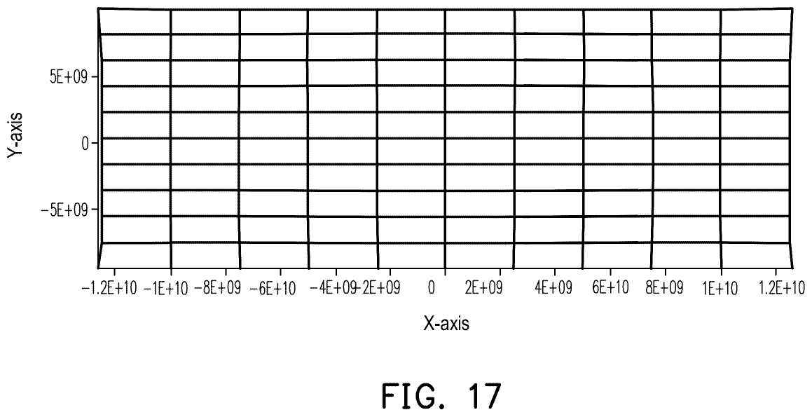

FIG. 16 is a relative illumination distribution diagram of the optical lens in FIG. 13. FIG. 17 is a schematic diagram of the TV distortion of the optical lens in FIG. 13. Referring to FIG. 16 and FIG. 17, in this embodiment, it may be seen from FIG. 16 that under different chief ray image height simulations, the relative illumination of the optical lens 110 may be greater than 70%. It may be seen from FIG. 17 that when the projection distance is 20 meters, the TV distortion is less than 1.3%. Therefore, the proper image quality can be provided.

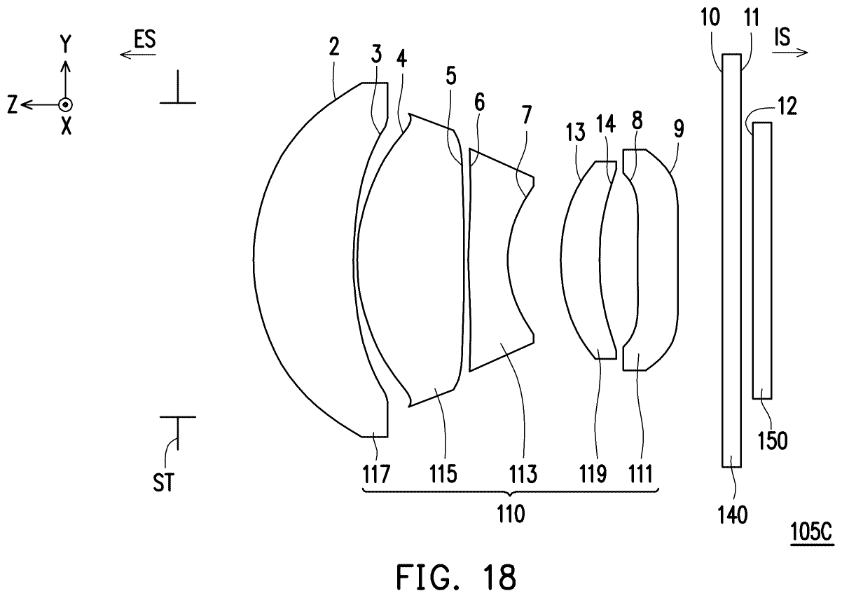

FIG. 18 is a schematic diagram of an imaging module according to the fourth embodiment of the disclosure. Referring to FIG. 18, an imaging module 105C of the fourth embodiment is roughly similar to the imaging module 105 of the first embodiment, and the differences between the two are as follows: various optical data and the aspherical coefficients of the optical lens 110 and the parameters between the lens elements 111, 113, 115, and 117 are more or less different. In addition, in this embodiment, the optical lens 110 further includes a fifth lens element 119 disposed between the first lens element 111 and the fourth lens element 117. Specifically, the fifth lens element 119 is disposed between the first lens element 111 and the second lens element 113, but the disclosure is not limited thereto.

The fifth lens element 119 has the positive diopter. A material of the fifth lens element 119 is plastic material. A light incident surface 14 of the fifth lens element 119 is a concave surface facing the imaging element 150. A light exit surface 13 of the fifth lens element 119 is a convex surface facing the stop ST. That is, the fifth lens element 119 is a concave-convex lens.

In this embodiment, the fifth lens element 119 is a spherical lense. That is, the light incident surface 14 and the light exit surface 13 of the fifth lens element 119 are both spherical surfaces, but the disclosure is not limited thereto.

In addition, in this embodiment, the first lens element 111 has the negative diopter. A material of the first lens element 111 is plastic material. A material of the second lens element 113 is plastic material. A material of the third lens element 115 is glass. A material of the fourth lens element 117 is plastic material. Other detailed optical data of the fourth embodiment are shown in Table 10 below.

TABLE 10
fourth embodiment
effective focal length = 6.71 mm, half view angle = 13.25°, image height = 1.6 mm.

| | | radius of | | | |
|---|---|---|---|---|---|
| | | curvature | distance | refractive | Abbe |
| element | surface | (mm) | (mm) | index | number |
| virtual image | | infinity | infinity | | |
| stop ST | | infinity | 1.20 | | |
| fourth lens element 117 | light exit surface 2 | 3.18 | 1.59 | 1.53 | 55.9 |
| | light incident surface 3 | 5.69 | 0.06 | | |
| third lens element 115 | light exit surface 4 | 3.21 | 1.72 | 1.51 | 63.9 |
| | light incident surface 5 | −20.96 | 0.06 | | |
| second lens element 113 | light exit surface 6 | 7.32 | 0.64 | 1.66 | 20.3 |
| | light incident surface 7 | 1.57 | 0.84 | | |
| fifth lens element 119 | light exit surface 13 | 2.57 | 0.63 | 1.66 | 20.3 |
| | light incident surface 14 | 4.12 | 0.61 | | |
| first lens element 111 | light exit surface 8 | 11.80 | 0.64 | 1.64 | 22.4 |
| | light incident surface 9 | 11.18 | 0.70 | | |
| protective cover 140 | light exit surface 10 | infinity | 0.30 | 1.50 | 61.1 |
| | light incident surface 11 | infinity | 0.01 | | |
| imaging element 150 | imagine surface12 | infinity | | | |

In the optical lens 110 of the fourth embodiment, the effective focal length of the optical lens 110 is 6.71 mm. The focal length of the third lens element 115 is 5.5 mm. The Abbe number of the third lens element 115 is 63.90. The focal length of the fourth lens element 117 is 10.96 mm. In other words, the optical lens 110 of the fourth embodiment also conforms to the conditional expression in the optical lens 110 of FIG. 1.

In this embodiment, the aspheric coefficients of the aspheric surfaces in formula (1) are shown in Table 11 below. In the present embodiment, the second-order aspheric coefficient a₂ of each aspheric surface is zero and thus is not listed in the table.

TABLE 11

| surface | K | a₄ | a₆ | a₈ | a₁₀ | a₁₂ | a₁₄ |
|---|---|---|---|---|---|---|---|
| 2 | 0.00E+00 | −1.26E−04 | 1.92E−04 | −6.08E−05 | 1.33E−05 | −2.53E−07 | −9.25E−08 |
| 3 | 0.00E+00 | 5.39E−04 | 2.85E−03 | −1.80E−03 | 7.30E−04 | −1.34E−04 | 8.27E−06 |
| 4 | 0.00E+00 | 3.31E−04 | 7.59E−04 | −4.33E−04 | 1.95E−04 | −2.05E−05 | −2.35E−06 |
| 5 | 0.00E+00 | 1.33E−03 | 1.73E−05 | 3.13E−04 | −6.98E−05 | −3.99E−05 | 6.21E−06 |
| 6 | 0.00E+00 | −4.75E−02 | 1.64E−02 | −5.19E−03 | 1.36E−03 | −3.10E−04 | 3.68E−05 |
| 7 | 0.00E+00 | −7.77E−02 | 1.99E−02 | −1.02E−02 | 1.05E−03 | 7.55E−04 | −4.54E−04 |
| 8 | 0.00E+00 | −4.94E−02 | −2.95E−02 | 2.23E−02 | −1.53E−02 | 5.04E−03 | −7.04E−04 |
| 9 | 0.00E+00 | −4.01E−02 | −2.33E−02 | 9.97E−03 | −2.64E−03 | 3.34E−04 | −1.65E−05 |

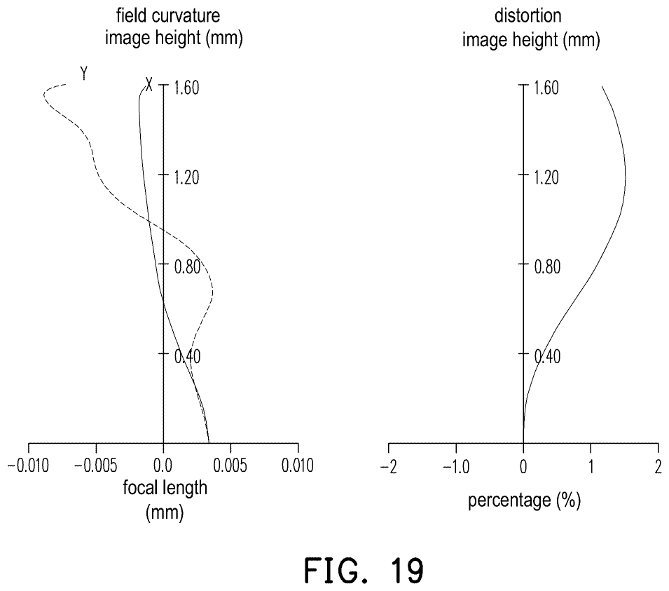

FIG. 19 is a diagram of the astigmatism and distortion of the optical lens in FIG. 18. Please refer to FIG. 19. FIG. 19 illustrates field curvature aberration in the sagittal direction (labeled X) and the tangential direction (labeled Y), and the distortion aberration of the optical lens 110 of the fourth embodiment. It may be seen from FIG. 19 that the field curvature aberration of the optical lens 110 of this embodiment falls within ±0.010 mm, indicating that the optical lens 110 of the fourth embodiment can effectively eliminate aberrations. The distortion aberration diagram shows that the distortion aberration is maintained within the range of ±2%, indicating that the distortion aberration of the fourth embodiment satisfies the imaging quality requirements of the optical lens 110, and the optical lens 110 can provide proper imaging quality.

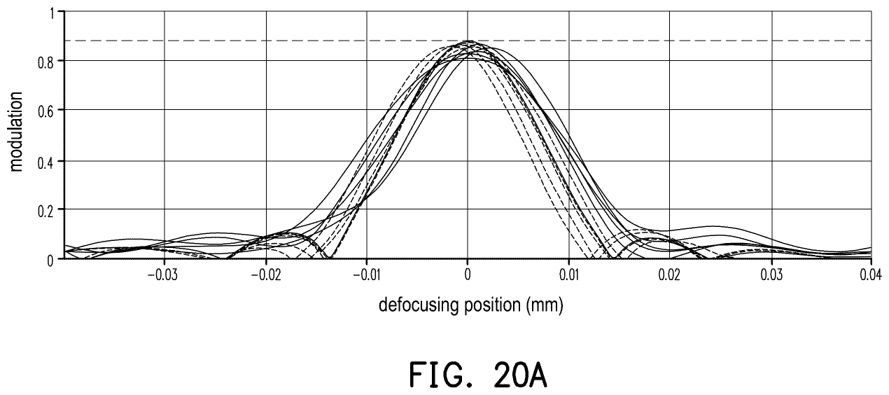

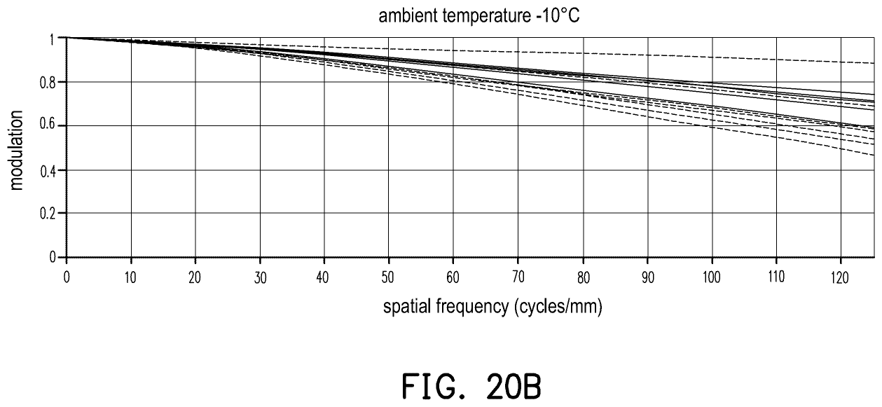

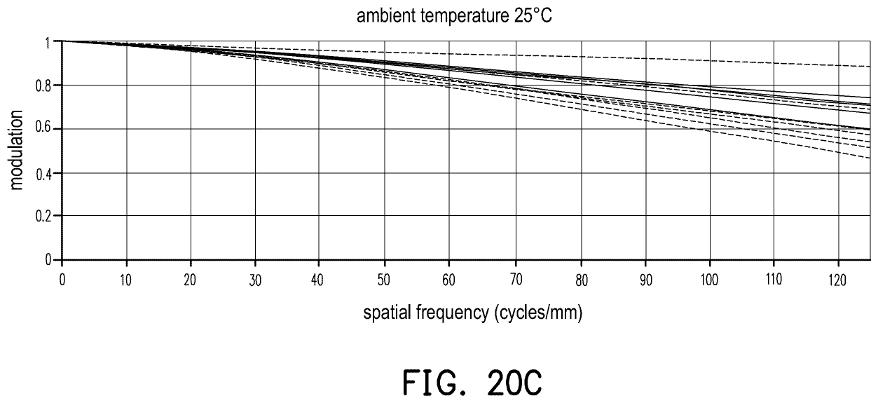

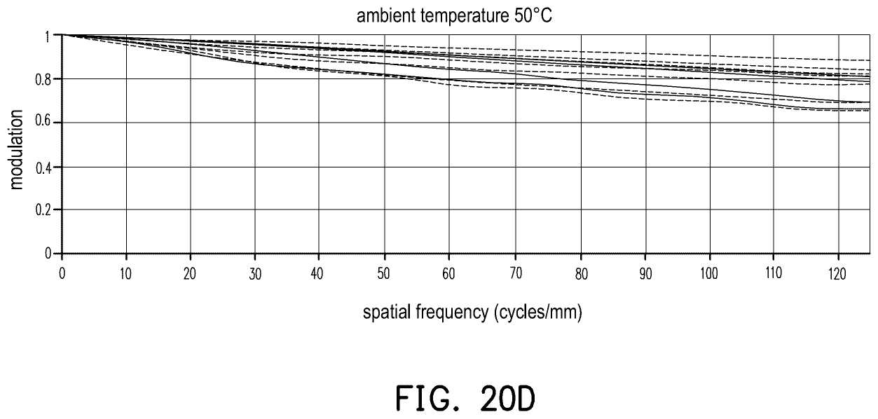

FIG. 20A to FIG. 20D are MTF curves of the optical lens in FIG. 18 at different temperatures. Referring to FIG. 20A to FIG. 20D, FIG. 20A shows the MTF curve of the green band of each lens element in the optical lens 110 at normal temperature; FIG. 20B to FIG. 20D respectively show the MTF curves of the optical lens 110 when the ambient temperatures are −10° C., 25° C., and 50° C. When the ambient temperatures of the fourth embodiment are −10° C., 25° C., and 50° C. respectively, the values of temperatures (° C.) of the first lens element 111, the second lens element 113, the third lens element 115, the fourth lens element 117, and the fifth lens element 119 of the optical lens 110 are shown in Table 12 below. It may be seen from FIG. 20A to FIG. 20D, when the optical lens 110 of the fourth embodiment is applied in thermal equilibrium within the ambient temperature range from −10°° C. to 50°° C. without re-adjusting the focal length thereof, the back focus of the optical lens has a thermal drift less than 0.01 mm corresponding to the center point of the projection image. Therefore, the proper image quality can be provided.

TABLE 12

| the ambient | fourth lens | third lens | second lens | fifth lens | first lens |
|---|---|---|---|---|---|
| temperature | element 117 | element 115 | element 113 | element 119 | element 111 |
| −10° C. | 13° C. | 15° C. | 17° C. | 19° C. | 21° C. |
| 25° C. | 48° C. | 50° C. | 52° C. | 54° C. | 56° C. |
| 50° C. | 73° C. | 75° C. | 77° C. | 79° C. | 81° C. |

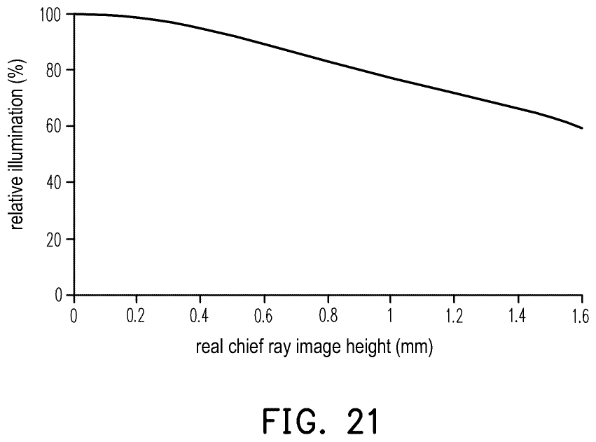

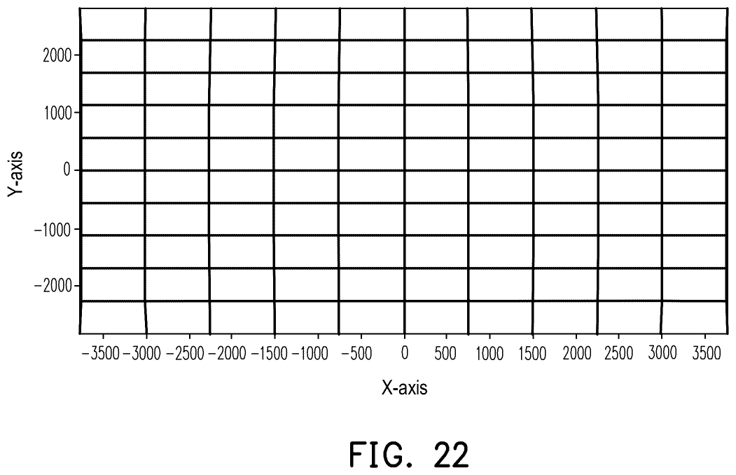

FIG. 21 is a relative illumination distribution diagram of the optical lens in FIG. 18. FIG. 22 is a schematic diagram of the TV distortion of the optical lens in FIG. 18. Referring to FIG. 21 and FIG. 22, in this embodiment, it may be seen from FIG. 21 that under different chief ray image height simulations, the relative illumination of the optical lens 110 can be greater than 60%. It may be seen from FIG. 22 that when the projection distance is 20 meters, the TV distortion is less than 0.4%. Therefore, the proper image quality can be provided.

To sum up, in the optical lens and head-mounted display device of the disclosure, the imaging module design may be used with a smaller single-color micro light-emitting diode panel as the imaging element, so no additional three-color light-combining prism is required, which allows the reduction of the overall volume of the imaging module. In addition, the projected image of the optical lens has high resolution up to 125 lp/mm. In addition, the selection of the positive and negative diopters of the lens of the optical lens with the positive and negative dn/dt takes into account the thermal drift under a specific lens temperature difference to control within an acceptable range. In addition, through the ultra-large aperture design of the optical lens, the optical lens still has sufficient brightness when outputting images using only the imaging element of single color.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure.

It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An optical lens, adapted to receive an image beam from an imaging element, wherein the optical lens sequentially comprises a first lens element, a second lens element, a third lens element, and a fourth lens element with a diopter arranged along an optical axis from a light incident-side to a light exit-side, and each of the first lens element, the second lens element, the third lens element and the fourth lens element comprises a light incident surface facing the light incident-side and allowing the image beam to pass through and a light exit surface facing the light exit-side and allowing the image beam to pass through;
the light incident surface of the first lens element is a concave surface;
the second lens element has a negative diopter, and the light exit surface of the second lens element is a convex surface;
the third lens element has a positive diopter, and the light incident surface of the third lens element is a convex surface;
the fourth lens element has a positive diopter, and the light incident surface of the fourth lens element is a concave surface; and
the optical lens receives the image beam from the light incident-side, the image beam forms a stop on the light exit-side, and the image beam has the smallest beam cross-sectional area at a position of the stop.

2. The optical lens according to claim 1, wherein the light exit surface of the first lens element is a convex surface.

3. The optical lens according to claim 1, wherein the light incident surface of the second lens element is a concave surface.

4. The optical lens according to claim 1, wherein the light exit surface of the third lens element is a convex surface.

5. The optical lens according to claim 1, wherein the light exit surface of the fourth lens element is a convex surface.

6. The optical lens according to claim 1, wherein materials of the first lens element, the second lens element, the third lens element and the fourth lens element are glass.

7. The optical lens according to claim 1, wherein the first lens element, the third lens element, and the fourth lens element are aspherical lenses.

8. The optical lens according to claim 1, wherein there are four lens elements with diopter in the optical lens.

9. The optical lens according to claim 1, further comprising a fifth lens element disposed between the first lens element and the fourth lens element, wherein the fifth lens element has a positive diopter.

10. The optical lens according to claim 9, wherein the fifth lens element is a spherical lens.

11. The optical lens according to claim 1, wherein the optical lens satisfies a conditional expression: 0.3<f_{L3}/f<3, wherein f_{L3} is a focal length of the third lens element, and f is an effective focal length of the optical lens.

12. The optical lens according to claim 1, wherein the optical lens satisfies a conditional expression: V_{L3}>30, wherein V_{L3} is an Abbe number of the third lens element.

13. The optical lens according to claim 1, wherein the optical lens satisfies a conditional expression: |f_{L4}/f|>1, where f_{L4} is a focal length of the fourth lens element, and f is an effective focal length of the optical lens.

14. The optical lens according to claim 1, wherein an aperture of the optical lens is less than 2.

15. The optical lens according to claim 1, wherein at least one of the lens elements with positive diopter in the optical lens satisfies a conditional expression: dn/dt<0, wherein dn/dt is a change in a refractive index of the lens element at unit temperature.

16. The optical lens according to claim 1, wherein a combined aberration of the light exit surface of the second lens element and the light incident surface of the third lens element and an aberration of the light incident surface of the second lens element offset each other.

17. A head-mounted display device, comprising:
an imaging element, configured to provide an image beam;
an optical lens, disposed on a transmission path of the image beam, wherein the optical lens sequentially comprises a first lens element, a second lens element, a third lens element, and a fourth lens element with a diopter arranged along an optical axis from a light incident-side to a light exit-side, and each of the first lens element, the second lens element, the third lens element and the fourth lens element comprises a light incident surface facing the light incident-side and allowing the image beam to pass through, and a light exit surface facing the light exit-side and allowing the image beam to pass through, wherein
the light incident surface of the first lens element is a concave surface;
the second lens element has a negative diopter, and the light exit surface of the second lens element is a convex surface;
the third lens element has a positive diopter, and the light incident surface of the third lens element is a convex surface;
the fourth lens element has a positive diopter, and the light incident surface of the fourth lens element is a concave surface; and
the optical lens receives the image beam from the light incident side, the image beam forms a stop on the light exit-side, and the image beam has the smallest beam cross-sectional area at a position of a stop; and
a waveguide element, disposed on the light exit-side of the optical lens and having an optical coupling entrance and an optical coupling exit, wherein the image beam from the imaging element passes through the optical lens and enters the waveguide element through the optical coupling entrance, and leaves the waveguide element through the optical coupling exit.

18. The head-mounted display device according to claim 17, wherein the imaging element is a self-luminous imaging panel.

19. The head-mounted display device according to claim 18, wherein the head-mounted display device does not have a light-combining prism.

20. The head-mounted display device according to claim 18, wherein the imaging element is an imaging panel that provides a monochromatic light source, and a wavelength of the image light beam is a single wavelength.
